(19) United States
(12) Patent Application Publication
(10) Pub. No.: US 2003/0222028 A1
(43) Pub. Date: Dec. 4, 2003

(54) Process and system for treating iron contamintated liquids

(76) Inventor: Jonathan M. Dietz, State College, PA (US)

Correspondence Address: Debra M. Parrish, P.C., Suite 200, 615 Washington Road, Pittsburgh, PA, 15228, US

(21) Appl. No.: 10/453,127

(22) Filed: Jun. 3, 2003

Related U.S. Application Data
(60) Provisional application No. 60/384,680, filed on Jun. 3, 2002.

(51) Int. Cl. C02F 1/52

(52) U.S. Cl. 210/722; 210/220

(57) ABSTRACT

The present invention is a method and system for treating iron-contaminated fluids. The system and method facilitates and uses an approach described herein as an activated iron sludge sequencing batch reactor (“AIS/SBR”) process. The AIS/SBR method oxidizes and removes ferrous iron as iron oxides from iron-contaminated fluids (such as mining-related discharge water, groundwater, surface water and industrial waste streams) and produces an effluent that is substantially devoid of iron and meets standards appropriate for natural discharge or further treatment. The AIS/SBR method of the present invention can be conducted in a single container assembly unit of the present invention, with time-controlled processing, to perform oxidation, precipitation and settling of iron from fluids. The method optionally includes the addition of alkaline material (e.g., limestone) when the initial liquid alkalinity (mg/L as CaCO₃) to ferrous iron (mg/L) ratio of the fluid to be treated is less than approximately 1.7. Excess accumulated iron oxides periodically are removed from the system of the present invention using a waste activated iron sludge (WAIS) system. The excess iron oxides in solution optionally may be directed to a secondary container in which the iron oxides are further concentrated.

### RELATED APPLICATION

This patent application claims priority from a provisional patent application entitled, “A Process and Device for Treating Iron Contaminated Liquids” filed Jun. 3, 2002, Serial No. 60/384,680.

### BACKGROUND OF THE INVENTION

1. Field of the Invention

This invention relates generally to a device for and the treatment of iron-contaminated fluid (e.g., mining-related discharge, groundwater, surface water and industrial waste streams) and, more particularly, to an apparatus and method for oxidizing and removing ferrous iron from iron-contaminated fluid, including mine drainage, and producing an effluent substantially free of iron.

2. Description of the Prior Art

Iron-contaminated fluid results from a variety of natural and anthropogenic processes with the later typically involving mining and industrial processing. Ferrous iron is released from minerals (e.g., pyrite, siderite, and hematite) through dissolution and redox processes. Industrial processing typically involves formation of reduced iron (Fe⁰) into various metallic compounds, with waste streams or subsequent oxidation causing elevated ferrous iron levels.

The most common source of iron-contaminated water results from mineral extraction and can be produced from either surface or deep mining practices where iron sulfide minerals contained in the minerals and surrounding formations are oxidized. The chemistry of mine drainage varies depending on overburden characteristics and mining and reclamation techniques. In the United States, millions of gallons of mine drainage is produced daily from both active and abandoned mine sites. Currently, treating mine drainage is an expensive endeavor involving land, construction, materials, operation, maintenance and chemical costs. Left untreated, mine drainage contaminates surface and groundwater impacting their social, recreational and commercial uses.

Currently, ferrous iron typically is removed from iron-contaminated waters employing chemical and passive treatment technologies. Current chemical treatment, more commonly used for industrial sources and active mines, requires continuous metering of caustic chemicals (e.g., lime, hydrated or soda ash) to raise the pH above 8 thereby increasing the rate of iron oxidation and precipitation as oxides (USEPA 1981). In addition to chemical additives, active treatment requires an assorted array of pumps, aeration equipment and multiple oxidation and settling basins. Iron oxide solids produced in chemical treatment are low density (1 to 2% solids) and slow settling (Dempsey & Jeon 2001). The low-density solids slowly settle in large open water basins, which require frequent and costly maintenance to remove and dispose the accumulated solids.

Passive treatment systems rely on natural amelioration processes that typically do not require pumps or metered chemical additions. In general, mine drainage passes through open water ponds and/or aerobic wetlands where abiotic and biotic processes contribute to the oxidation and precipitation of iron (Hedin & Nairn 1993). Iron removal in passive treatment systems require much larger land areas (10 to 20 times greater) than chemical treatment, which can become excessive for high flow and/or high iron concentration mine drainage discharges. Further, iron removal in passive systems can be problematic with performance varying with season, influent flow and concentration. Iron oxide solids produced by passive treatment systems have much higher sludge density (15-30%) and settle at faster rates than chemical treatment solids (Dempsey & Jeon, 2001).

Ferrous iron oxidation is usually the limiting step in the iron removal from iron-contaminated mine drainage. Iron oxidation has been described to occur by two separate processes known as homogeneous oxidation, a solution oxidation process, and heterogeneous oxidation, a solid/solution interface oxidation process. Homogeneous oxidation involves soluble Fe²⁺, FeOH⁺, or Fe(OH)₂^{o} species in the presence of dissolved oxygen (Millero et al. 1987). This oxidation is strongly dependent on pH with slow oxidation occurring at pH 6 and rapid oxidation occurring above pH 8. Heterogeneous oxidation involves sorbed ferrous iron on the surface of iron oxides in which the iron oxide acts as a catalyst (Tamura et al. 1976). At high iron oxide concentrations, heterogeneous oxidation has been found to produce oxidation rates greater than 50 times the rates observed in passive treatment and comparable rates to chemical treatment (Dietz & Dempsey 2001).

Alkalinity may need to be generated to complete the precipitation of oxidized ferrous iron where the source water alkalinity (mg/L as CaCO₃) to iron (mg/L as Fe) ratio is less 1.7. The low pH (approximately 5 to 6) and/or high carbonic acid concentrations (P_{CO2} approximately 0.1 to 0.5) found in many iron-contaminated mine drainage results in the rapid dissolution of carbonate minerals (such as calcite), thereby producing alkalinity at concentrations higher than will typically occur in natural systems. A type of passive treatment, known as Anoxic Limestone Drains (ALD), has been found to produce alkalinity greater than 300 mg/L (Hedin & Watzlaf 1994). Other research has found carbonate dissolution occurs rapidly until a pH greater than 6 is achieved and the rate of dissolution is directly proportional to the surface area of the carbonate mineral present (Chou et al 1989; Pearson & McDonnell 1975).

Therefore, it is an object of the present invention to provide a treatment process and apparatus to oxidize and remove ferrous iron from iron-contaminated mine waters at a pH typically found in iron-contaminated waters.

Another object of this invention is to provide an alkaline source (e.g., limestone) directly to the reactor in cases in which source water alkalinity is insufficient to complete the precipitation process.

It is also an object of the invention to develop a simple means of collecting and concentrating the iron oxides produced by the iron-contaminated water treatment processes and apparatuses.

Other objects will readily apparent after reading the description and reviewing the figures described below.

### SUMMARY OF INVENTION

The invention involves a method and an apparatus employing a container assembly having an aeration and/or mixing apparatus, a storage capacity for liquid, a decant apparatus to remove treated liquid, time and/or flow-based process controls, and a waste activated iron sludge (WAIS) apparatus. Some embodiments of the invention optionally include an apparatus to add an alkaline material (e.g., calcite limestone). Other preferred embodiments optionally include a separate container assembly to thicken oxides produced by the treatment process. The invention has the capacity to remove up to 99% of the ferrous iron in iron-contaminated water and produce a circumneutral pH.

The following description will provide a complete understanding of the invention when reviewed in connection with the accompanying drawing figures.

### BRIEF DESCRIPTION OF THE DRAWINGS

FIG. 1 is a schematic plan view of a preferred embodiment of the system and method of the present invention.

FIG. 2 is a schematic cross-sectional view of a preferred embodiment of the AIS/SBR container assembly system and method of the present invention.

### DESCRIPTION OF PREFERRED EMBODIMENTS

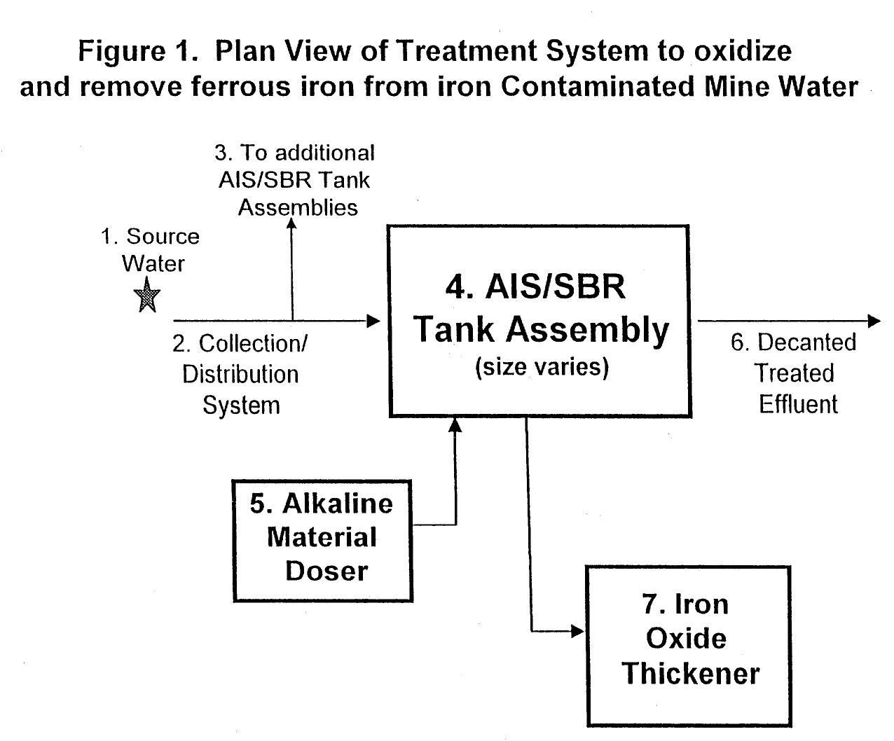

FIG. 1 is a plan view of a preferred embodiment of the process of the present invention. Iron-contaminated water (1) is directed into at least one AIS/SBR tank assembly (4) and more preferably a plurality of AIS/SBR tank assemblies. The means of directing the iron-contaminated water into at least one AIS/SBR assembly source may by gravitational force, by pumping the iron-contaminated water into the AIS/SBR tank assembly, decanting from a flow surge tank assembly, or a combination of such methodologies. When a plurality of AIS/SBR tank assemblies are used in the treatment of iron-contaminated water, a means for collecting and distributing the iron-contaminated water, such as a header system or distribution tank assembly, precedes the AIS/SBR tank assemblies (3).

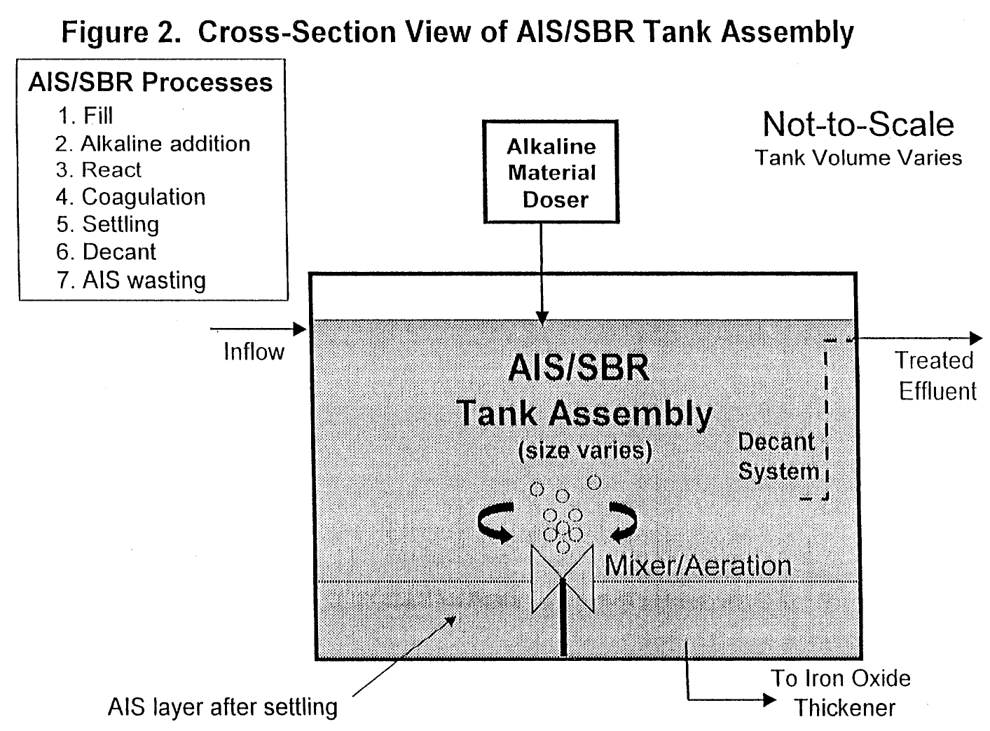

The source of iron-contaminated water is directed through a first conduit (2) that is engaged with the inlet of at least one and preferably a plurality of AIS/SBR tank assemblies. Each AIS/SBR tank assembly of the present invention is substantially similar to that depicted in the cross-sectional view of an AIS/SBR tank assembly shown in FIG. 2.

A system of the present invention has the following features:

1) A means for directing the fluid to be treated into a container assembly having the features described herein;

2) A means of aeration and mixing within the container assembly to provide sufficient oxygen for ferrous iron oxidation and suspension of the activated iron sludge (AIS) in solution;

3) A means of storing AIS within the container assembly to maintain sufficiently high reactor iron oxide concentrations to catalyze ferrous iron oxidation;

4) A means of decanting the container assembly to remove treated iron-contaminated fluid;

5) A means to remove excess iron oxides from the container assembly; and

6) A means of controlling the duration of the various container assembly processes such as fill, reaction, flocculation, settling and decant.

The method of the present invention includes the following steps:

1) Directing a fluid to be treated into a container assembly having the features described herein;

2) Aerating and mixing iron-contaminated fluid within a container assembly to provide sufficient oxygen for ferrous iron oxidation and suspension of the activated iron sludge (AIS) in solution;

3) Storing AIS within the container assembly to maintain sufficiently high reactor iron oxide concentrations to catalyze ferrous iron oxidation;

4) Decanting the container assembly to remove treated iron-contaminated fluid;

5) Removing excess iron oxides from the container assembly; and

6) Controlling the duration of the various container assembly processes such as fill, reaction, flocculation, settling and decant to optimize the process and desired output characteristics.

The method may also include a plurality of container assemblies operated with an inlet header and a means for selectively isolating the flow to selected container assemblies. The method includes the following steps in an AIS/SBR container assembly:

Fill Step. Iron-contaminated fluid enters at least one AIS/SBR tank assembly. Preferably, for an efficient process, the tank is filled to capacity with such iron-contaminated fluid. In some preferred embodiments the iron-contaminated fluid is mixed, aerated or both during the fill step. The temporal duration of the fill step may vary depending on fluid flow rate and characteristics, tank volume and the chemistry of the iron-contaminated fluid.

Alkaline Addition Optional Step. Alkaline material optionally may be added to a AIS/SBR tank assembly after or during the fill step preferably using a doser assembly (5 on FIG. 1). The amount of alkaline material added to the iron-contaminated fluid in the AIS/SBR tank assembly may vary depending on the chemistry of the iron-contaminated fluid and the amount of alkalinity needed to complete iron precipitation.

React Step. Oxidation and precipitation occurs in an AIS/SBR tank assembly during the react step. In addition, in cases in which alkaline material is added, the dissolution of the material and the generation of alkalinity occur in conjunction with the oxidation and precipitation of iron. Iron oxides retained in the AIS/SBR Tank Assembly are suspended in fluid providing a surface for heterogeneous ferrous iron oxidation. Iron oxides in suspension during the react step for mine drainage typically range from approximately 500 up to 5,000 mg/L as iron and depend on the chemistry of the iron-contaminated fluid and the mixed fluid in the AIS/SBR tank assembly during the react step. Precipitation of ferric iron produced from the oxidation of ferrous iron is rapid and requires much less time than the ferrous iron oxidation. React durations will vary depending on iron-contaminated fluid ferrous iron concentration, the volume of iron-contaminated fluid to be treated, pH, dissolved oxygen and alkalinity. When the iron-contaminated fluid is mine drainage and standard AIS/SBR tank assemblies are used, the duration of the react period is generally less than 2 hours.

Flocculation Optional Step. AIS and new iron oxides formed during the react step may benefit from an optional flocculation step to create larger iron oxide particles that settle more readily and easily. The optional flocculation step involves slow mixing [JMD1]°to provide a fluid velocity in the reactor equal to or less than 0.001 ft/sec in an AIS/SBR tank assembly to enable iron oxide particle interaction and agglomeration. Flocculation durations vary depending on the desired output and characteristics of the fluid and particles after the react step. When treating iron-contaminated mine drainage in standard AIS/SBR tank assemblies, this step may last as long as one-half hour in duration.

Settle Step. Iron oxides are removed from suspension in the AIS/SBR tank assembly by substantially ceasing and mixing or aeration treatment of the iron-contaminated fluid. The substantially quiescent conditions in the AIS/SBR Tank Assembly permit AIS and newly formed iron oxides to settle and accumulate in the bottom of an AIS/SBR tank assembly. Settle step durations vary depending on the AIS concentration in the AIS/SBR tank assembly and desired purity of the resulting fluid. When treating iron-contaminated mine drainage in standard AIS/SBR assemblies, this step generally is less than two hours in duration.

Decant Step. Subsequent to the settle step, treated fluid in an AIS/SBR tank assembly is removed from the tank assembly during the decant step. The decant step involves the removal, preferably rapid removal, of substantially clarified supernatant fluid that overlies fluid containing settled AIS. Typically, less than 75% of the fluid in the tank is decanted although both the volume and time of the decant step will vary depending on the desired characteristics of the decanted fluid, the volume of the tank and the rapidity and thoroughness of the settling step. In a preferred embodiment for treating iron-contaminated water, the decant period to remove 75% of the volume of the fluid in the tank wherein the tank is a standard volume, the mine drainage has standard characteristics, the time for the decant step generally is less than one-half hour.

AIS Wasting Step. Excess AIS that results from newly formed iron oxides, periodically are removed from the AIS/SBR tank assembly in a step known as AIS wasting. AIS wasting may occur during any of the above steps and optionally can be conducted during a plurality of steps. The duration, volume of AIS removed, purity of AIS removed and frequency of this step will vary depending on the characteristics of the iron contaminated fluid to be treated, the application and duration of the other steps, the use of optional steps, and the desired characteristics of effluent.

According to the method of the present invention, at least one, but preferably a plurality, AIS/SBR container assembly has an outlet (symbolized by step 6 on FIG. 1) through which decanted fluid is discharged from the AIS/SBR container assembly. The outlet may discharge into a receiving water body or an additional treatment system, as required to meet effluent criteria. Decanted fluid or effluent from an AIS/SBR container assembly, when used to treat mine drainage, preferably has pH greater than six and iron concentrations of 5 mg/L or less, depending on the effluent criteria.

The method and system according to the present invention optionally includes an additional method of and system for thickening iron oxides produced by the foregoing method and system. An iron oxide thickening system comprises:

1) A means of conveying fluids containing iron oxides to a container;

2) A container in which fluids containing iron oxides are retained to provide additional settling time, slow mixing of the fluid to increase solids, or both;

3) A means of removing concentrated iron oxide solids from the container; and

4) A means of decanting supernatant substantially free of iron solids from the container.

Iron oxide thickening steps of the method of the present invention include:

1) Conveying fluids containing iron oxides to a container;

2) Retaining a fluid containing iron oxides in a container for sufficient time for iron oxides to concentrate in the fluid by removal of water accomplished by providing additional settling time, slow mixing of the fluid containing iron oxide to increase the removal of water, or to both settle and mix such fluids;

3) Removing concentrated iron oxide solids from the container; and

4) Decanting a supernatant substantially free of iron solids from the container.

In an embodiment of the present invention that employs this method and system, waste activated iron sludge (WAIS), the excess AIS produced by an iron oxidation treatment method or system according to the present invention, is directed into a container. Such fluid can be directed into the container by using a variety of means including pumps, gravitational force, a combination of both, or other means. See step 7 on FIG. 1. The container and thickening step decreases the fluid content of the iron oxide solids and thereby increases the solid content of the iron oxide solids. The iron oxide thickener container system consists of a container assembly containing a supernatant decant pump and a solid recovery pump. The container assembly may also provide a means for mixing the fluid to aid in removing excess water from the iron oxide solids. Iron oxides resulting from such a step and system typically have a solid content up to 40%. Solids recovered from such processes and systems have commercial reuse potential.

It will be understood from the above description that the present invention is related to a new device and treatment process for iron-contaminated water, such as mine drainage. This process and device may decrease the treatment area or volume by a factor greater than 20 compared to passive treatment approaches and a decrease in treatment costs, associated with chemicals and operation, in comparison to conventional chemical treatment. The process may prove to be an economical alternative to both current passive treatment and chemical treatment approaches. The process has the added benefit of producing a relatively pure iron oxide solid that may have commercial value.

Although preferred embodiments of the invention have been described in detail herein, it will be appreciated by those skilled in the art that various modifications and alternatives to the preferred embodiments may be developed in light of the overall teaching of the disclosure. Accordingly, the particular arrangements are illustrative only and are not limiting as to the scope of the invention, which is to be given full breadth of the amended claims and any and all equivalents thereof.

What is claimed is:

1. A system for removing ferrous iron from a fluid comprising:
a. At least one first container for receiving iron-contaminated fluid wherein said first container has at least one means of ingress and egress of fluid;
b. A means of transporting iron-contaminated fluid into said first container;
c. A means of aerating and mixing iron-contaminated fluid within said first container;
d. A means of decanting substantially iron-free supernatant fluid from said first container without disturbing settled iron oxides; and
e. A means of controlling the volume and temporal duration of transporting fluids in and out of said first container, aerating and mixing a fluid within said first container, and maintaining a fluid in a quiescent state in said first container.

2. A system according to claim 1 having a plurality of first containers.

3. A system according to claim 2 further comprising a means for selectively directing the flow of a fluid to at least one of said first containers.

4. A system of claim 1, 2 or 3 further comprising a means for delivering alkaline-bearing material into said first container.

5. A system of claim 1, 2, or 3 further comprising:
a. A means for conveying fluid from a first container into a second container;
b. A means of mixing fluids in said second container;
c. A means of removing iron oxides from said second container; and
d. A means of decanting a substantially iron-free supernatant fluid from said second container.

6. A system of claim 4 further comprising:
a. A means for conveying fluid from a first container into a second container;
b. A means of mixing fluids in said second container;
c. A means of removing iron oxides from said second container; and
d. A means of decanting a substantially iron-free supernatant fluid from said second container.

7. A method of removing ferrous iron from a fluid comprising:
a. Filling at least one first container with an iron-containing fluid;
b. Aerating the fluid within a first container sufficiently to ensure ferrous iron oxidation;
c. Mixing fluid within the first container sufficiently to maintain a suspension of iron oxide solids necessary to catalyze ferrous iron oxidation;
d. Storing activated iron sludge within a first container sufficiently to maintain high reactor iron oxide concentrations necessary to catalyze ferrous iron oxidation;
e. Decanting a substantially iron-free supernatant fluid from a first container; and
f. Removing excess iron oxides from a first container.

8. A method according to claim 7 wherein a plurality of first containers are filled with a fluid to be treated.

9. A method according to claim 8 further wherein fluid is selectively directed either simultaneously or sequentially into first containers for treatment.

10. A method of claim 7, 8 or 9 further comprising adding alkaline-bearing material into a first container in sufficient quantity to provide sufficient alkalinity to precipitate iron oxides in a fluid to be treated.

11. A method of claims 7, 8, or 9 further comprising:
a. Conveying fluid from a first container into a second container;
b. Mixing fluids in a second container;
c. Removing iron oxides from a second container; and
d. Decanting a substantially iron-free supernatant fluid from a second container.

12. A method of claim 10 further comprising:
a. Conveying fluid from a first container into a second container;
b. Mixing fluids in a second container;
c. Removing iron oxides from a second container
d. Decanting a substantially iron-free supernatant fluid from a second container.

13. A method of claim 7, 8 or 9 further comprising mixing fluids sufficiently to promote flocculation after said storing of activated iron sludge within a first container sufficiently to maintain high reactor iron oxide concentrations necessary to catalyze ferrous iron oxidation.
